(19) United States
(12) Patent Application Publication
(10) Pub. No.: US 2025/0284657 A1
(43) Pub. Date: Sep. 11, 2025

(54) COMMUNICATION DEVICE, COMMUNICATION METHOD, AND PROGRAM

(71) Applicant: SONY SEMICONDUCTOR SOLUTIONS CORPORATION, KANAGAWA (JP)

(72) Inventors: KANTA SATO, KANAGAWA (JP); KUMIKO MAHARA, KANAGAWA (JP)

(21) Appl. No.: 19/105,015

(22) PCT Filed: Aug. 15, 2023
(86) PCT No.: PCT/JP2023/029486

§ 371 Date: Feb. 19, 2025

(30) Foreign Application Priority Data
Aug. 29, 2022 (JP) 2022-135890

(51) Int. Cl. G06F 13/42; G06F 13/36

(52) U.S. Cl. CPC G06F 13/4291; G06F 13/36; G06F 2213/0016

(57) ABSTRACT

The present technology relates to a communication device, a communication method, and a program that enable detection of abnormality of data in a signal portion of a predetermined pattern of serial communication. A communication device of the present technology performs I2C communication with an external communication device serving as a master, and detects an abnormality in a signal portion of a predetermined pattern generated by the external communication device on the basis of at least one of a first time constraint set for a Low period or a second time constraint set for a High period of a clock signal after completion of transmission of a response signal subsequent to data. The present technology can be applied to an image sensor.

### TECHNICAL FIELD

The present technology relates to a communication device, a communication method, and a program, and more particularly, to a communication device, a communication method, and a program enabled to detect an abnormality of data in a signal portion of a predetermined pattern of serial communication.

### BACKGROUND ART

There is an inter-integrated circuit (I2C) as a method of serial communication. The I2C communication is performed by one device operating as a master and the other device operating as a slave between devices connected to each other by two signal lines of a serial data line (SDA) and a serial clock line (SCL).

### CITATION LIST

### Patent Document

Patent Document 1: Japanese Patent Application Laid-Open No. 2008-197752

### SUMMARY OF THE INVENTION

### Problems to be Solved by the Invention

Functional safety and security functions are required also in serial communication such as I2C communication. For example, it is required that an abnormality can be detected in a case where tampering is performed on data by an external attack.

A start position and an end position of data transmission of serial communication each are represented by a combination of predetermined patterns of High and Low of signals flowing through a plurality of signal lines. Data to be transmitted is arranged between a signal portion of a pattern indicating the start position of the data transmission and a signal portion of a pattern indicating the end position of the data transmission. In a case where an attack is made on a signal portion of such a predetermined pattern generated by a master, communication is different from intended communication.

It is conceivable to respond to an attack by detecting an error by using a cyclic redundancy code (CRC) or detecting tampering by using a message authentication code (MAC); however, in a case where data of a signal portion of a predetermined pattern indicating the start position/end position of the data transmission is changed, it is difficult to detect an abnormality. In a case where the CRC or the MAC is used for the I2C communication, calculation of the CRC or the MAC is usually performed on the basis of data to be transmitted.

The present technology has been made in view of such a situation, and enables detection of an abnormality of data in a signal portion of a predetermined pattern of serial communication. SOLUTIONS TO PROBLEMS

A communication device of one aspect of the present technology includes: a communication unit that performs I2C communication with an external communication device serving as a master; and a detection unit that detects an abnormality in a condition portion generated by the external communication device on the basis of at least one of a first time constraint set for a Low period or a second time constraint set for a High period of a clock signal after completion of transmission of a response signal subsequent to data.

A communication device of another aspect of the present technology includes: a communication unit that performs I2C communication with an external communication device serving as a slave; and a control unit that transmits, to the external device by using the I2C communication, a parameter indicating a period of at least one of a first time constraint on a Low period or a second time constraint on a High period of a clock signal after completion of transmission of a response signal subsequent to data and to be used in the external device for detection of an abnormality in a condition portion generated by the communication unit.

In the one aspect of the present technology, the I2C communication is performed with the external communication device serving as the master, and the abnormality in the condition portion generated by the external communication device is detected on the basis of the at least one of the first time constraint set for the Low period of or the second time constraint set for the High period of the clock signal after completion of transmission of the response signal subsequent to the data.

In the another aspect of the present technology, the I2C communication is performed with the external communication device serving as the slave, and the parameter is transmitted to the external device with use of the I2C communication, which indicates the period of the at least one of the first time constraint on the Low period or the second time constraint on the High period of the clock signal after completion of transmission of the response signal subsequent to the data and is used in the external device for detection of the abnormality in the condition portion generated by the communication unit.

### BRIEF DESCRIPTION OF DRAWINGS

FIG. 1 is a diagram illustrating a configuration example of a communication system according to an embodiment of the present technology.

FIG. 2 is a diagram illustrating an example of transmission of error information.

FIG. 3 is a diagram illustrating an example of data transmission by I2C communication.

FIG. 4 is a diagram illustrating examples of a start condition, a stop condition, and a repeated start condition.

FIG. 5 is a diagram illustrating an example of an ACK and a NACK.

FIG. 6 is a diagram illustrating an example of a constraint period.

FIG. 7 is an enlarged view illustrating a range of an arrow #1 of FIG. 6.

FIG. 8 is an enlarged view illustrating a range of an arrow #2 of FIG. 6.

FIG. 9 is a diagram illustrating a specific example of a length of each period in a standard-mode.

FIG. 10 is a diagram illustrating a specific example of a length of each period in a fast-mode and a fast-mode plus.

FIG. 11 is a diagram illustrating states of an SCL and an SDA at the time of generation of the repeated start condition and at the time of data communication.

FIG. 12 is a flowchart explaining a flow of a series of processing steps of detecting an attack on the repeated start condition.

FIG. 13 is a diagram illustrating an example of an abnormality detected by the processing in FIG. 12.

FIG. 14 is a diagram illustrating states of the SCL and the SDA at the time of generation of the stop condition and at the time of data communication.

FIG. 15 is a flowchart explaining a flow of a series of processing steps of detecting an attack on the stop condition.

FIG. 16 is a diagram illustrating an example of an abnormality detected by the processing in FIG. 15.

FIG. 17 is a diagram illustrating an example of an attack on I2C communication.

FIG. 18 is a diagram illustrating an example of a MAC area.

FIG. 19 is a diagram illustrating an example of data transmission by SPI communication.

FIG. 20 is a diagram illustrating a timing chart of each of signals of the SPI communication.

FIG. 21 is a diagram illustrating an example of each period.

FIG. 22 is a block diagram illustrating a detailed configuration example of an image sensor.

FIG. 23 is a diagram illustrating an example of data transmission by SLVS-EC.

FIG. 24 is a diagram illustrating an example of a format used for the data transmission by SLVS-EC.

### MODE FOR CARRYING OUT THE INVENTION

Hereinafter, modes for carrying out the present technology will be described. The description will be given in the following order.
1. Configuration example of communication system
2. About I2C communication
3. About SPI communication
4. Configuration of image sensor
5. About high-speed communication IF
6. Modifications

### <<Configuration Example of Communication System>>

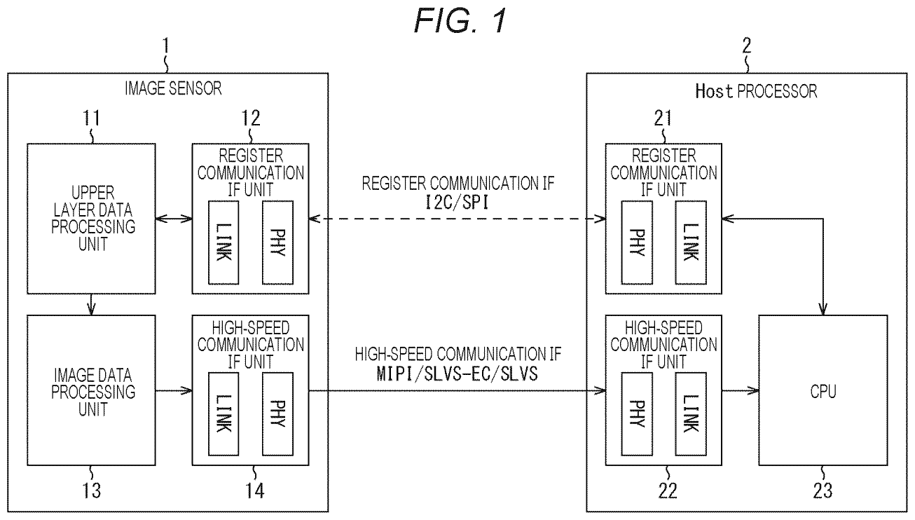

FIG. 1 is a diagram illustrating a configuration example of a communication system according to an embodiment of the present technology.

The communication system of FIG. 1 includes an image sensor 1 and a host processor 2 connected to each other. A plurality of image sensors may be connected to one host processor 2. The image sensor 1 and the host processor 2 may be mounted in a device in the same housing such as a camera or a smartphone, or may be mounted in devices in different housings.

The image sensor 1 and the host processor 2 are connected to each other by a register communication IF as indicated by a dashed arrow in FIG. 1. The register communication IF is a communication IF using a register, such as an inter integrated circuit (I2C) or a serial peripheral interface (SPI).

Furthermore, the image sensor 1 and the host processor 2 are connected to each other by a high-speed communication IF as indicated by a solid arrow in FIG. 1. The high-speed communication IF is a high-speed communication IF of a predetermined standard such as a mobile industry processor interface (MIPI), a scalable low voltage signaling-embedded clock (SLVS-EC), or a scalable low voltage signaling (SLVS).

The image sensor 1 is a sensor such as a CMOS image sensor (CIS). The image sensor 1 is provided with a sensor unit including a plurality of pixels arranged, and in addition, an upper layer data processing unit 11, a register communication IF unit 12, an image data processing unit 13, and a high-speed communication IF unit 14 as illustrated in FIG. 1.

The upper layer data processing unit 11 performs upper layer processing of register communication performed in the register communication IF unit 12. The upper layer data processing unit 11 acquires information transmitted from the host processor 2 by register communication, and outputs the acquired information to the image data processing unit 13. The upper layer data processing unit 11 stores information to be transmitted in a register and transmits the information to the host processor 2 by register communication.

Furthermore, the upper layer data processing unit 11 detects an abnormality in a case where an attack such as tampering is performed on register communication. The image sensor 1 is provided with a function of detecting an abnormality in register communication. In a case where an abnormality in register communication is detected, information indicating the detection is transmitted to the host processor 2.

The register communication IF unit 12 performs register communication, which is communication using the register communication IF, with the host processor 2. An operation mode related to imaging, such as an exposure time, a gain, a resolution, or a frame rate, is set by register communication performed with the host processor 2.

The image data processing unit 13 acquires image data of each frame output by the sensor unit, and performs various types of processing on the acquired image data. In the image data processing unit 13, security processing such as encryption is appropriately performed on the image data.

The high-speed communication IF unit 14 transmits the image data processed in the image data processing unit 13 to the host processor 2 by using the high-speed communication IF. In a case where an abnormality in register communication is detected, the high-speed communication IF unit 14 adds error information that is information indicating the detection to the image data and transmits the image data to the host processor 2.

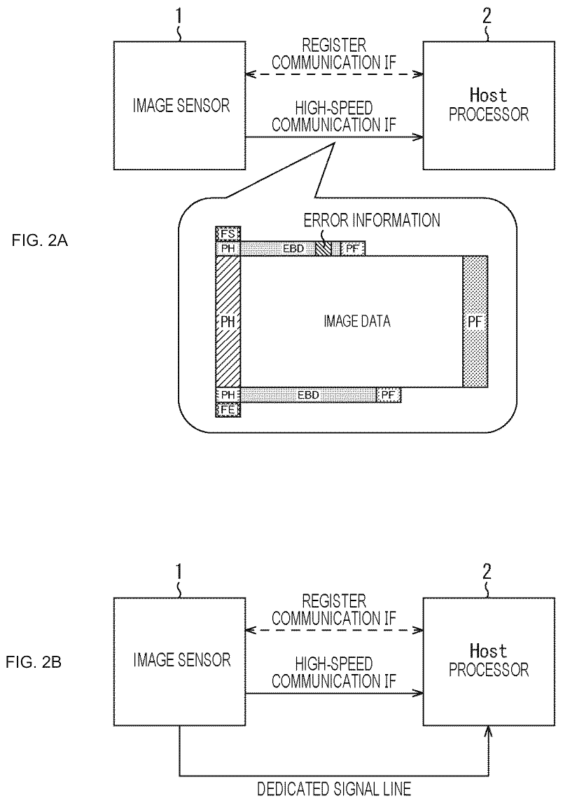

FIG. 2 is a diagram illustrating an example of transmission of error information.

As illustrated in a balloon in A of FIG. 2, in the image sensor 1, frame data of a predetermined format is generated for each piece of image data of one frame. Transmission of image data from the image sensor 1 to the host processor 2 is performed by using the frame data.

As indicated by hatching, the error information is included in, for example, embedded data (EBD) of the frame data, and is transmitted to the host processor 2. A frame format illustrated in A of FIG. 2 is configured by arrangement of an EBD in a line before image data for one frame. The image data for one frame, which is data of a plurality of lines, is arranged after the line in which the EBD is arranged.

A line of frame start (FS) and a line of frame end (FE) are arranged at the head and the end of the frame format, respectively. The line of the frame start is a line of data in which a value of 1 is set to the frame start of the packet header. Furthermore, the line of the frame end is a line of data in which a value of 1 is set to the frame end of the packet header. In A of FIG. 2, the packet header is indicated as “PH” and the packet footer is indicated as “PF”. Details of the frame format used for data transmission in the high-speed communication IF will be described later.

Instead of using the high-speed communication IF, as illustrated in B of FIG. 2, transmission of the error information may be performed by using a dedicated signal line connecting the image sensor 1 and the host processor 2 to each other. In this case, a dedicated terminal used for transmission and reception of error information is provided in each of the image sensor 1 and the host processor 2.

Returning to the description of FIG. 1, the host processor 2 functioning as a host (master) for register communication is provided with a register communication IF unit 21, a high-speed communication IF unit 22, and a central processing unit (CPU) 23.

The register communication IF unit 21 of the host processor 2 performs register communication with the image sensor 1. The register communication IF unit 21 transmits a write command to the image sensor 1, and causes data to be written in a register provided in the image sensor 1, to transmit data to the image sensor 1. Furthermore, the register communication IF unit 21 transmits a read command to the image sensor 1, and reads data stored in the register, to receive the data transmitted from the image sensor 1.

The high-speed communication IF unit 22 receives frame data transmitted by using the high-speed communication IF. Image data included in the frame data received by the high-speed communication IF unit 22 is output to the CPU 23.

The CPU 23 performs processing of the image data transmitted from the image sensor 1 and received by the high-speed communication IF unit 22. In the CPU 23, security processing is performed, such as decryption of the encrypted image data. Furthermore, in a case where error information is transmitted from the image sensor 1, the CPU 23 performs error processing such as stopping register communication or outputting a warning. A control unit that controls operation of the host processor 2 may be implemented by a field programmable gate array (FPGA) instead of the CPU.

As described above, the image sensor 1 and the host processor 2 are connected to each other by two communication IFs of the high-speed communication IF and the register communication IF. The image sensor 1 and the host processor 2 have a function as a communication device. The high-speed communication IF is used for transmission and reception of data having a large amount of data such as image data, and the register communication IF is used for transmission and reception of data having a small amount of data such as information regarding setting of an operation mode.

### <<About I2C Communication>>

Here, a description will be given of I2C communication that is register communication performed in the communication system of FIG. 1.

### <Basic Communication Protocol>

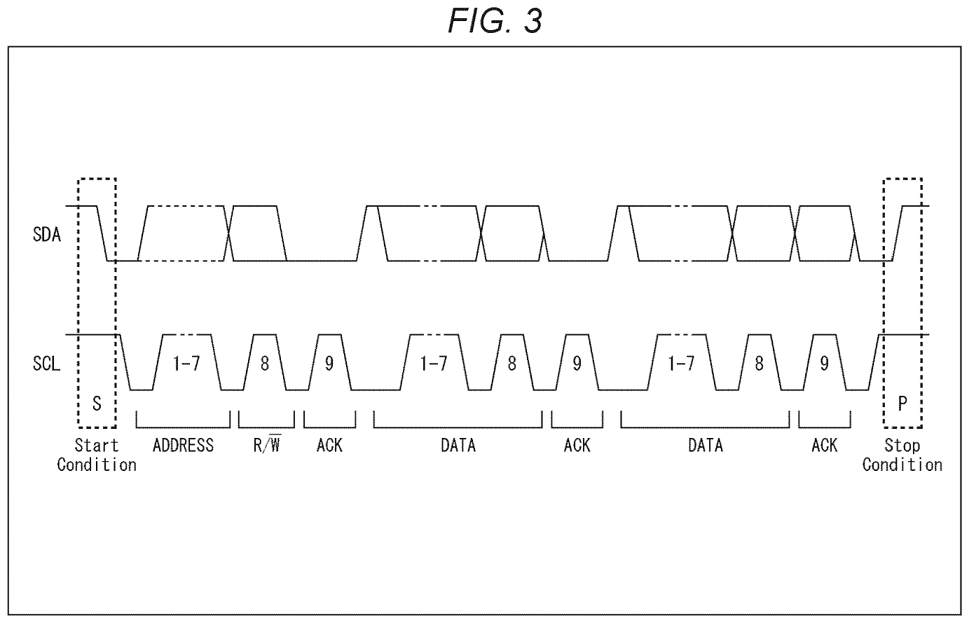

FIG. 3 is a diagram illustrating an example of data transmission by the I2C communication. The I2C communication is performed by using two signal lines of a serial data line (SDA) and a serial clock line (SCL). The upper part of FIG. 3 illustrates a signal of the SDA, and the lower part illustrates a signal of the SCL.

As indicated by a dashed line, the data transmission by the I2C communication is started at a start condition and ended at a stop condition. Such a condition portion (communication protocol portion) is generated by the register communication IF unit 21 of the host processor 2 serving as a master of the I2C communication.

The start condition is defined by a change of the SDA from High to Low in a High period of the SCL.

The stop condition is defined by a change of the SDA from Low to High in a High period of the SCL.

It is possible to transmit a repeated start condition between the start condition and the stop condition. The repeated start condition has a function similar to that of the start condition.

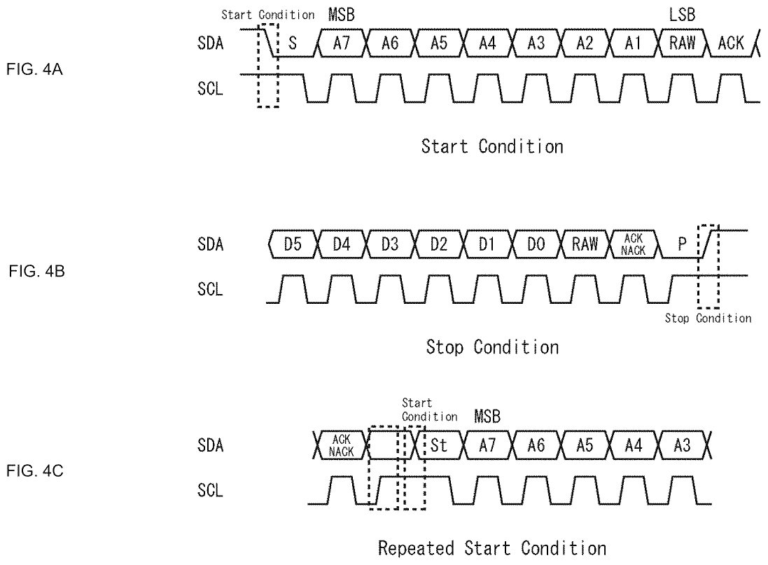

The start condition, the stop condition, and the repeated start condition are illustrated in A to C of FIG. 4. As illustrated in C of FIG. 4, the repeated start condition is configured by a start condition before a stop condition after a start condition is generated.

As illustrated in FIG. 3, an address of a slave is transmitted after the start condition. In the communication system of FIG. 1, an address of the image sensor 1 is transmitted as the address of the slave. The address of the slave is represented by 7 bits. A R/W bit indicating read/write of data is transmitted in the 8th bit subsequent to the address of the slave. The R/W bit of “0” represents write of data, and the R/W bit of “1” represents read of data.

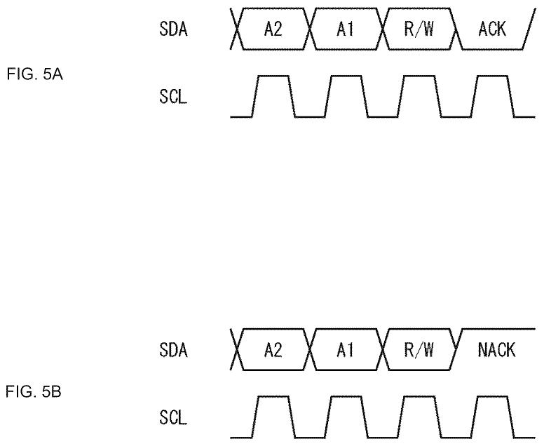

An acknowledgement (ACK) is transmitted subsequent to the R/W bit, and then each piece of data is transmitted in units of 8 bits. The ACK is added after each piece of data (8 bits). The ACK added after each piece of data is an acknowledgement signal used for notification that data reception has succeeded. As illustrated in A of FIG. 5, the ACK is defined by a combination of the SCL being High and the SDA being Low.

Instead of the ACK, a not acknowledgement (NACK) is appropriately transmitted that is a negative acknowledgment signal indicating that data reception has failed. As illustrated in B of FIG. 5, the NACK is defined by a combination of the SCL being High and the SDA being High.

### <Constraint for Detecting Attack on Condition Portion>

### Constraint Period

In the I2C communication of the communication system of FIG. 1, a constraint of High/Low of each of the SCL and the SDA is set for a predetermined period after completion of transmission of the ACK/NACK subsequent to 8-bit data. In a case where High/Low of each of the SCL and the SDA in a constraint period, which is a period in which the constraint is set, indicates a value different from the constraint, it is detected by the host processor 2 that an attack such as tampering has been performed on the condition portion. The attack such as tampering is detected as an abnormality in the I2C communication.

The host processor 2 is provided with a counter that counts periods of High/Low of the SCL and the SDA in the constraint period after completion of transmission of the ACK/NACK. In the host processor 2, whether or not the constraint is violated is determined on the basis of a counter value.

In a case where the constraint is violated, it is determined that an attack is made on the condition portion. Furthermore, in a case where the constraint is not violated, it is determined that no attack is made on the condition portion. An attack on the condition portion is detected on the basis of the constraint.

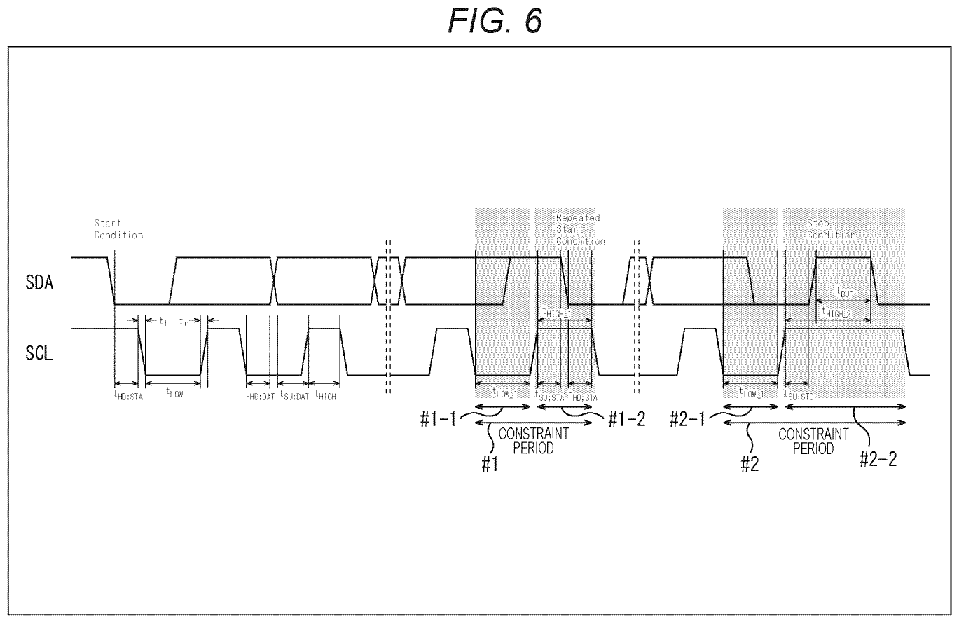

FIG. 6 is a diagram illustrating an example of the constraint period.

A period indicated by an arrow #1 in FIG. 6 is a constraint period for detecting an attack on the repeated start condition. A period indicated by an arrow #2 is a constraint period for detecting an attack on the stop condition.

Arrows #1-1 and #2-1 indicate Low periods of the SCL before generation of a condition after completion of transmission of the ACK/NACK subsequent to 8-bit data. Furthermore, arrows #1-2 and #2-2 indicate High periods of the SCL at the time of generation of a condition after completion of transmission of the ACK/NACK subsequent to 8-bit data. Constraints are respectively set for the Low periods of the SCL indicated by the arrows #1-1 and #2-1 and the High periods of the SCL indicated by the arrows #1-2 and #2-2.

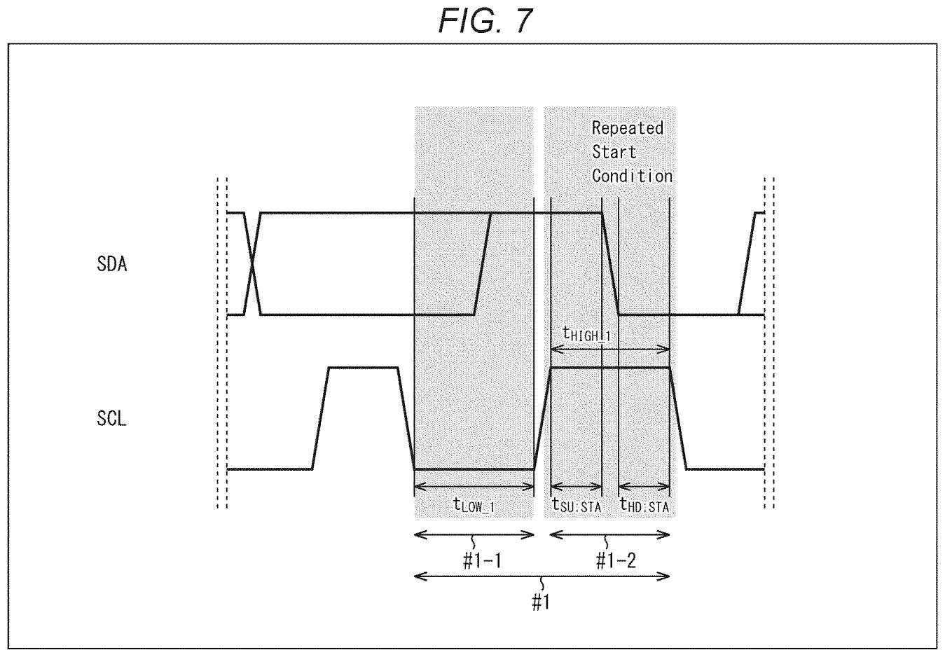

FIG. 7 is an enlarged view illustrating a range of the arrow #1 of FIG. 6.

In a case where the Low period (period of the arrow #1-1) of the SCL before generation of the repeated start condition after completion of transmission of the ACK/NACK is shorter than or longer than a period t_{LOW_1} that is an assumed period, it is determined that an attack is made.

Furthermore, in a case where the High period (period of the arrow #1-2) of the SCL at the time of generation of the repeated start condition after completion of transmission of the ACK/NACK is shorter or longer than a period t_{HIGH_1} that is an assumed period, it is determined that an attack is made. The period t_{HIGH_1} is set as a period longer than a period obtained by addition of a period t_{SU;STA} that is a setup period of the repeated start condition and a period t_{HD;STA} that is a hold period.

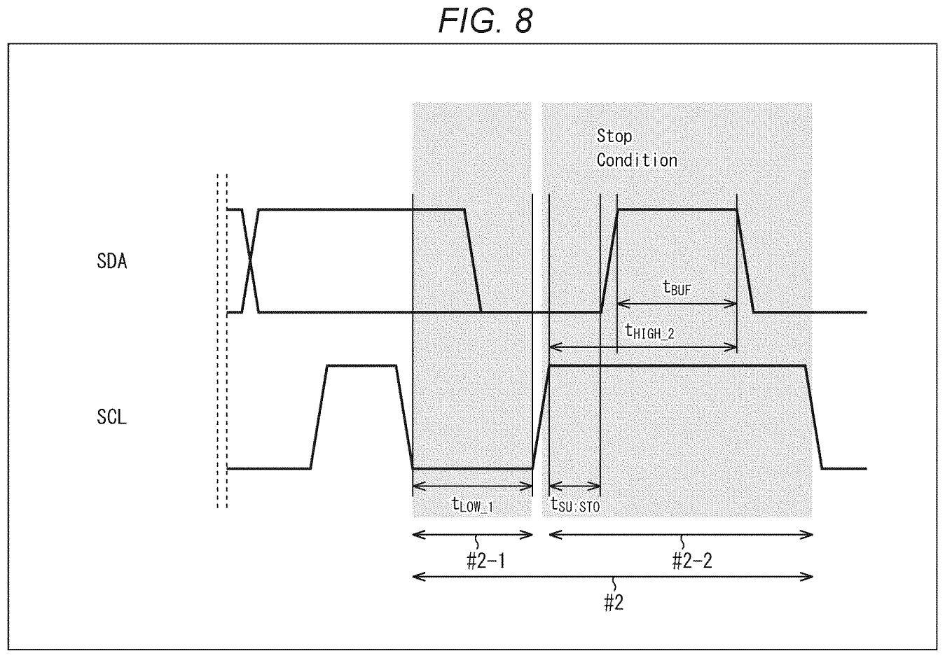

FIG. 8 is an enlarged view illustrating a range of the arrow #2 of FIG. 6.

In a case where the Low period (period of the arrow #2-1) of the SCL before generation of the stop condition after completion of transmission of the ACK/NACK is shorter than or longer than the period t_{LOW_1} that is the assumed period, it is determined that an attack is made.

Furthermore, in a case where the High period (period of the arrow #2-2) of the SCL at the time of generation of the stop condition after completion of transmission of the ACK/NACK is shorter or longer than a period t_{HIGH_2} that is an assumed period, it is determined that an attack is made. The period t_{HIGH_2} is set as a period longer than a period obtained by addition of a period t_{SU;STO} that is a setup period of the stop condition and a period t_{BUF} that is a bus free period between the stop condition and the start condition.

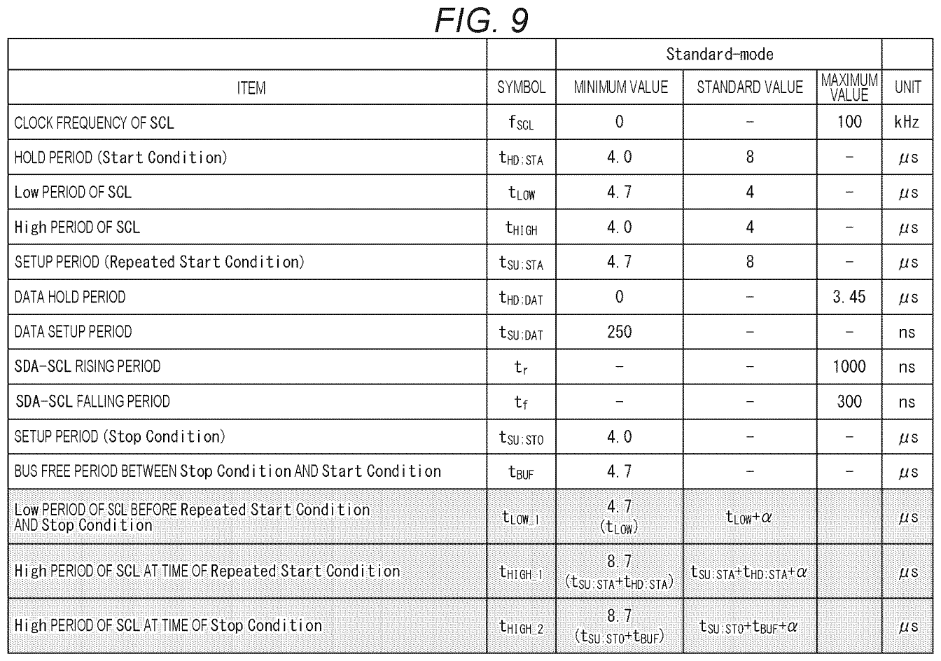

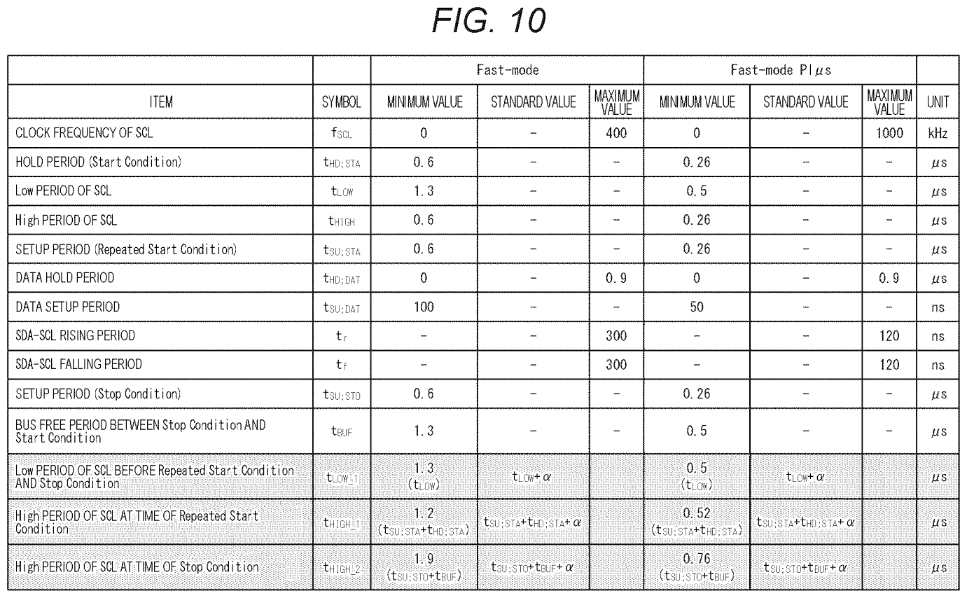

FIGS. 9 and 10 are diagrams illustrating specific examples of a length of each period in a standard-mode, a fast-mode, and a fast-mode plus. Transmission modes of the I2C communication include the standard-mode, the fast-mode, and the fast-mode plus.

For example, at the time of data transmission in the standard-mode, a minimum value of the period t_{LOW_1} in FIG. 7 is represented as 4.7 μs that is the same as a time of a period t_{LOW}. Furthermore, minimum values of the period t_{SU;STA} and the period t_{HD;STA} in FIG. 7 are represented as 4.7 μs and 4.0 μs, respectively. A minimum value of the period t_{HIGH_1} is represented as 8.7 μs obtained by addition of them.

Similarly, at the time of data transmission in the standard-mode, the minimum value of the period t_{LOW_1} in FIG. 8 is also expressed as 4.7 μs that is the same as the time of the period t_{LOW}. Furthermore, minimum values of the period t_{SU;STO} and the period t_{BUF} in FIG. 8 are represented as 4.0 μs and 4.7 μs, respectively. A minimum value of the period t_{HIGH_2} is represented as 8.7 μs obtained by addition of them.

### Details of Detecting Attack on Repeated Start Condition

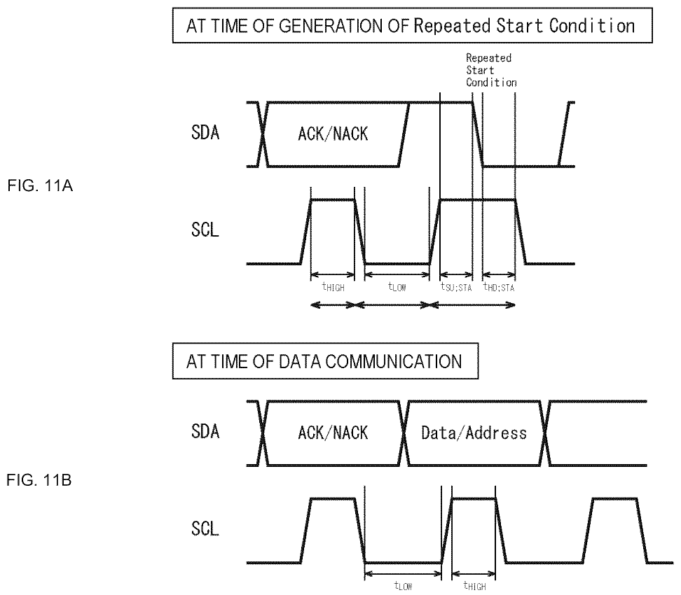

FIG. 11 is a diagram illustrating states of the SCL and the SDA at the time of generation of the repeated start condition and at the time of data communication.

The upper part of FIG. 11 illustrates a period near the ACK/NACK at the time of generation of the repeated start condition. Furthermore, the lower part of FIG. 11 illustrates a period near the ACK/NACK at the time of data communication. As indicated by a bidirectional arrow, the High period and the Low period are counted of each of the SCL and the SDA after detection of the ACK/NACK subsequent to 8-bit data. In a case where detection is performed of an attack on the ACK/NACK, the High period of the ACK/NACK itself is also counted.

Here, the Low period (period t_{LOW}) of the SCL after completion of transmission of the ACK/NACK is the same period for a data portion and a protocol portion.

In this case, when the Low period of the SCL is longer than or equal to the period t_{LOW_1} or shorter than or equal to the period t_{LOW_1}, it is determined that an attack is made. A predetermined margin period may be added to the period t_{LOW_1}.

On the other hand, the High period of the SCL after completion of transmission of the ACK/NACK is different between the data portion and the protocol portion as follows.

High period of SCL at time of data communication: t_{HIGH} (+α)

High period of SCL at time of generation of repeated start condition: t_{SU;STA}+t_{HD;STA} (+α)

The High period of the SCL at the time of generation of a condition is set as a longer period than the High period (period t_{HIGH}) of the SCL at the time of data communication. The period t_{HIGH} is a period that satisfies the following relationship as compared with the period t_{SU;STA}.

$${t}_{HIGH} + α \leq {t}_{SU ; STA}$$

A period α that is a margin period is a period in which jitter is considered. As the period α, 0 may be set. Furthermore, a period t_{SU;STA}+t_{HD;STA} is a sufficiently longer period than the period t_{HIGH}.

In this case, when a bus is in a busy state and the High period of the SCL is longer than or equal to the period t_{HIGH}, the period is determined to be a period at the time of generation of a condition. In a case where the period is determined to be a period at the time of generation of a condition, it is determined that an attack is made when the repeated start condition has not been generated for a certain period or more.

Each of parameters used for the above determination may be defined as a standard, or may be settable in a register of the image sensor 1. Each of parameters of t_{LOW_1}, t_{HIGH}, t_{SU;STA}, and t_{HD;STA} is defined as a standard or set in a register.

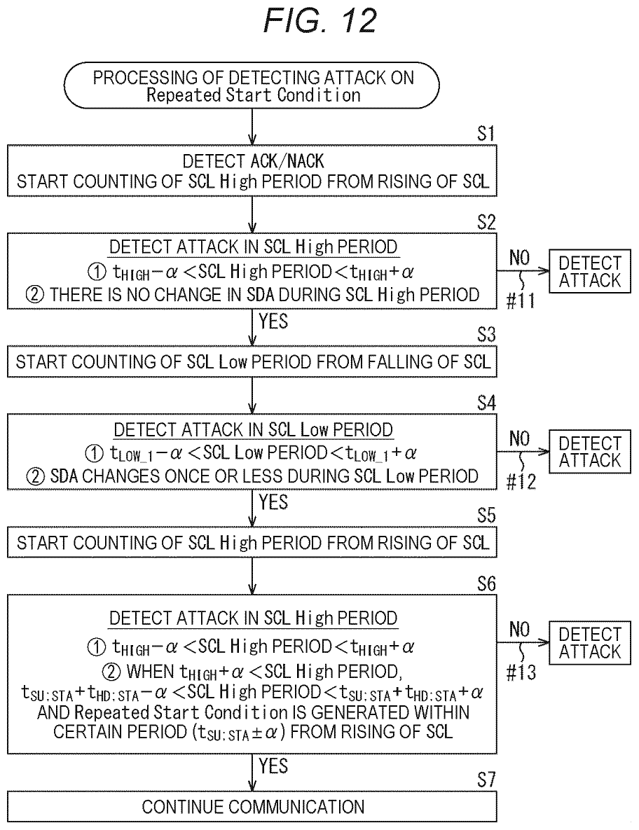

With reference to a flowchart of FIG. 12, a description will be given of a flow of a series of processing steps of detecting an attack on the repeated start condition.

In step S1, the image sensor 1 starts counting of the High period of the SCL from rising of the SCL in response to detection of the ACK/NACK subsequent to 8-bit data.

In step S2, the image sensor 1 performs detection of an attack in the High period of the SCL. The processing in this step is processing for detecting an attack on the ACK/NACK.

In step S2, it is determined whether or not the following condition is satisfied.

Condition 1: t_{HIGH}−α<SCL High period<t_{HIGH}+α

Condition 2: There is no change in the SDA during the High period of the SCL

In a case where the two conditions are not satisfied, an abnormality is detected as indicated by an arrow #11. In a case where the two conditions are satisfied, the processing proceeds to step S3.

In step S3, the image sensor 1 starts counting of the Low period of the SCL from falling of the SCL.

In step S4, the image sensor 1 performs detection of an attack in the Low period of the SCL. The processing in this step is processing for detecting an attack on the Low period after transmission of the ACK/NACK.

In step S4, it is determined whether or not the following condition is satisfied.

Condition 1: t_{LOW_1}−α<SCL Low period<t_{LOW_1}+α

Condition 2: The SDA changes once or less during the low period of the SCL

In a case where the two conditions are not satisfied, an abnormality is detected as indicated by an arrow #12. In a case where the two conditions are satisfied, the processing proceeds to step S5.

In step S5, the image sensor 1 starts counting of the High period of the SCL from rising of the SCL.

In step S6, the image sensor 1 performs detection of an attack in the High period of the SCL. The processing in this step is processing for detecting an attack on the data itself in a case where data communication is performed, and processing for detecting an attack on the repeated start condition in a case where the repeated start condition is generated.

In step S6, it is determined whether or not the following condition is satisfied.

Condition 1: t_{HIGH}−α<SCL High period<t_{HIGH}+α

Condition 2: In a case of t_{HIGH}+α<SCL High period, t_{SU;STA}+t_{HD;STA}−α<SCL High period<t_{SU;STA}+t_{HD;STA}+α

and

The repeated start condition is generated within a certain period (t_{SU;STA}±α) from rising of the SCL

In a case where neither condition is satisfied, an abnormality is detected as indicated by an arrow #13.

On the other hand, in a case where it is determined in step S6 that the condition 1 is satisfied, it is determined that no attack is made at the time of data communication. Thereafter, the processing proceeds to step S7, and the I2C communication is continued.

In a case where it is determined in step S6 that the condition 2 is satisfied, it is determined that no attack is made at the time of generation of the repeated start condition. Thereafter, the processing proceeds to step S7, and the I2C communication is continued.

By setting the above constraint after completion of transmission of the ACK/NACK subsequent to 8-bit data, it is possible to detect an attack on the repeated start condition.

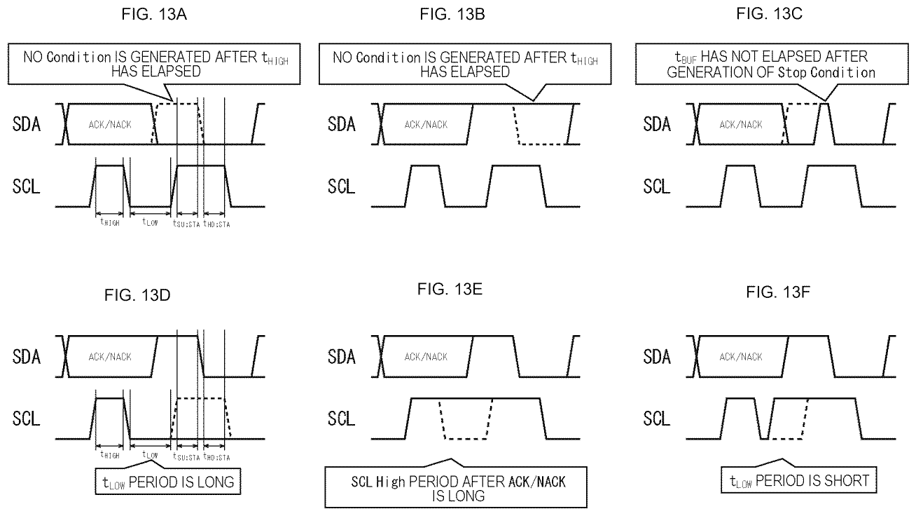

FIG. 13 is a diagram illustrating an example of an abnormality detected by the processing in FIG. 12.

A and B of FIG. 13 illustrate abnormalities in a case where no condition is generated after the period t_{HIGH} has elapsed. C of FIG. 13 illustrates an abnormality in a case where the period t_{BUF} has not elapsed after generation of the stop condition, and D of FIG. 13 illustrates an abnormality in a case where the period t_{LOW} is long. E of FIG. 13 illustrates an abnormality in a case where the High period of the SCL after completion of transmission of the ACK/NACK is long, and F of FIG. 13 illustrates an abnormality in a case where the period t_{LOW} is short.

### Details of Detecting Attack on Stop Condition

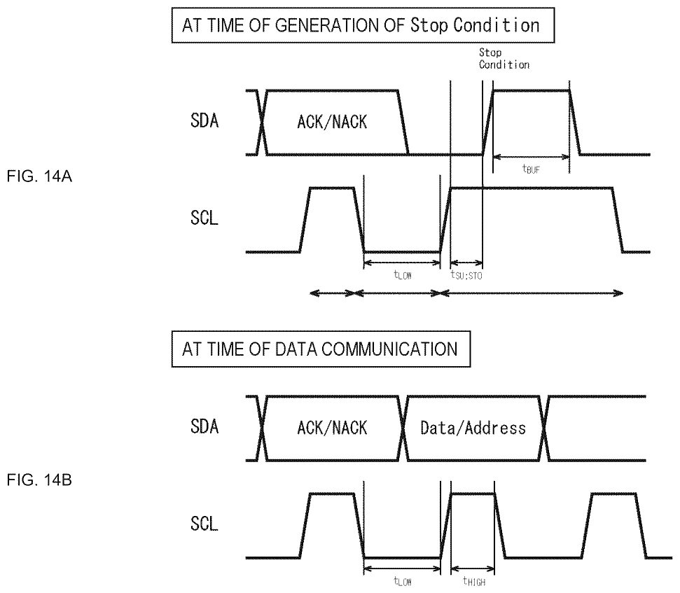

FIG. 14 is a diagram illustrating states of the SCL and the SDA at the time of generation of the stop condition and at the time of the data communication.

The upper part of FIG. 14 illustrates a period near the ACK/NACK at the time of generation of the stop condition. Furthermore, the lower part of FIG. 14 illustrates a period near the ACK/NACK at the time of data communication. As indicated by a bidirectional arrow, the High period and the Low period are counted of each of the SCL and the SDA after detection of the ACK/NACK subsequent to 8-bit data.

Here, the Low period (period t_{LOW}) of the SCL after completion of transmission of the ACK/NACK is the same period for a data portion and a protocol portion.

In this case, when the Low period of the SCL is longer than or equal to the period t_{LOW_1} or shorter than or equal to the period t_{LOW_1}, it is determined that an attack is made. A predetermined margin period may be added to the period t_{LOW_1}.

On the other hand, the High period of the SCL after completion of transmission of the ACK/NACK is different between the data portion and the protocol portion as follows.

High period of SCL at time of data communication: t_{HIGH} (+α)

High period of SCL at time of generation of stop condition: t_{SU;STO}+t_{BUF} (+α)

The High period of the SCL at the time of generation of a condition is set as a longer period than the High period (period t_{HIGH}) of the SCL at the time of data communication. The period t_{HIGH} is a period that satisfies the following relationship as compared with the period t_{SU;STO}.

$${t}_{HIGH} + α \leq {t}_{SU ; STO}$$

The period α is a period in which jitter is considered. As the period α, 0 may be set. Furthermore, the period t_{SU;STO}+t_{BUF} is a sufficiently longer period than the period t_{HIGH}.

In this case, when the bus is in the busy state and the High period of the SCL is longer than or equal to the period t_{HIGH}, the period is determined to be a period at the time of generation of a condition. In a case where the period is determined to be a period at the time of generation of a condition, it is determined that an attack is made when the stop condition has not been generated for a certain period or more.

Each of parameters used for the above determination may be defined as a standard, or may be settable in a register of the image sensor 1. Each of parameters of t_{LOW_1}, t_{HIGH}, t_{SU;STO}, and t_{BUF} is defined as a standard or set in a register.

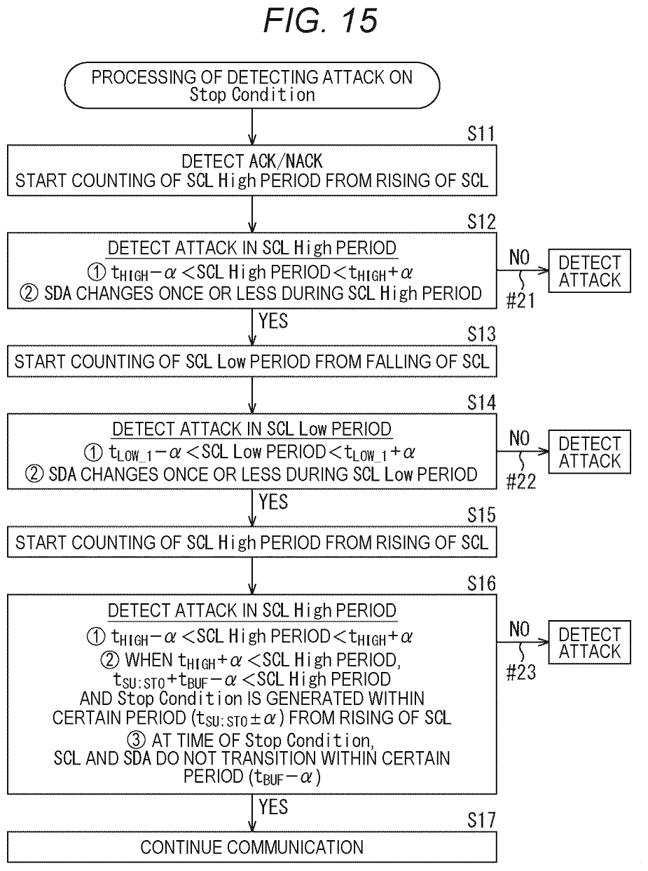

With reference to a flowchart of FIG. 15, a description will be given of a flow of a series of processing steps of detecting an attack on the stop condition.

In step S11, the image sensor 1 starts counting of the High period of the SCL from rising of the SCL in response to detection of the ACK/NACK subsequent to 8-bit data.

In step S12, the image sensor 1 performs detection of an attack in the High period of the SCL. The processing in this step is processing for detecting an attack on the ACK/NACK.

In step S12, it is determined whether or not the following condition is satisfied.

Condition 1: t_{HIGH}−α<SCL High period<t_{HIGH}+α

Condition 2: The SDA changes once or less during the High period of the SCL

In a case where the two conditions are not satisfied, an abnormality is detected as indicated by an arrow #21. In a case where the two conditions are satisfied, the processing proceeds to step S13.

In step S13, the image sensor 1 starts counting of the Low period of the SCL from falling of the SCL.

In step S14, the image sensor 1 performs detection of an attack in the Low period of the SCL. The processing in this step is processing for detecting an attack on the Low period after transmission of the ACK/NACK.

In step S14, it is determined whether or not the following condition is satisfied.

Condition 1: t_{LOW_1}−α<SCL Low period<t_{LOW_1}+α

Condition 2: The SDA changes once or less during the Low period of the SCL

In a case where the two conditions are not satisfied, an abnormality is detected as indicated by an arrow #22. In a case where the two conditions are satisfied, the processing proceeds to step S15.

In step S15, the image sensor 1 starts counting of the High period of the SCL from rising of the SCL.

In step S16, the image sensor 1 performs detection of an attack in the High period of the SCL. The processing in this step is processing for detecting an attack on the data itself in a case where data communication is performed, and processing for detecting an attack on the stop condition in a case where the stop condition is generated.

In step S6, it is determined whether or not the following condition is satisfied.

Condition 1: t_{HIGH}−α<SCL High period<t_{HIGH}+α

Condition 2: In a case of t_{HIGH}+α<SCL High period, t_{SU;STO}+t_{BUF}−α<SCL High period

and

The stop condition is generated within a certain period (t_{SU;STO}±α) from rising of the SCL

Condition 3: At the time of generation of the stop condition, the SCL and the SDA do not transition within a certain period (t_{BUF}−α)

In a case where neither condition is satisfied, an abnormality is detected as indicated by an arrow #23.

On the other hand, in a case where it is determined in step S16 that the condition 1 is satisfied, it is determined that no attack is made at the time of data communication. Thereafter, the processing proceeds to step S17, and the I2C communication is continued.

In a case where it is determined in step S16 that the condition 2 and the condition 3 are satisfied, it is determined that no attack is made at the time of generation of the stop condition. Thereafter, the processing proceeds to step S17, and the I2C communication is continued.

By setting the above constraint after completion of transmission of the ACK/NACK subsequent to 8-bit data, it is possible to detect an attack on the stop condition.

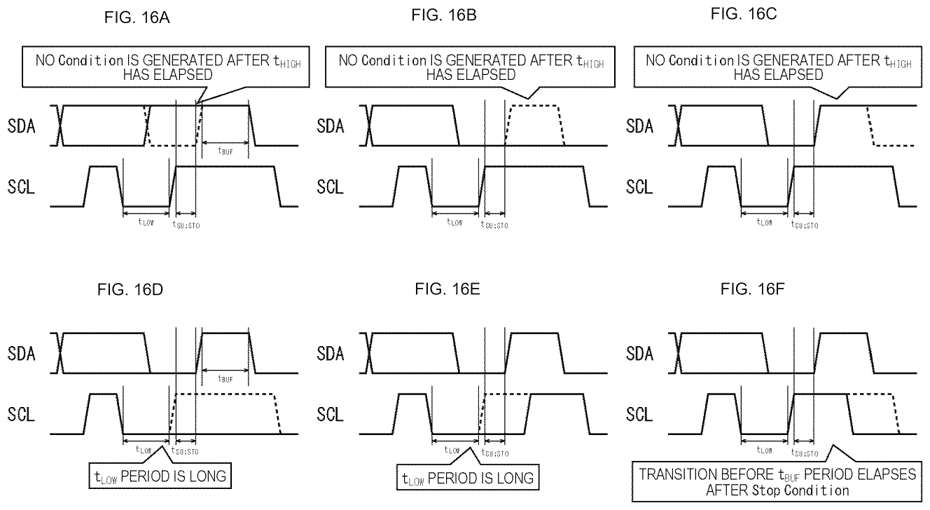

FIG. 16 is a diagram illustrating an example of an abnormality detected by the processing in FIG. 15.

A, B, and C of FIG. 16 illustrate abnormalities in a case where no condition is generated after the period t_{HIGH} has elapsed. D and E of FIG. 16 illustrate abnormalities in a case where the period t_{LOW} is long. F of FIG. 16 illustrates an abnormality in a case where the SCL and the SDA transition before the period t_{BUF} elapses after generation of the stop condition.

### <Example of Attack on I2C Communication>

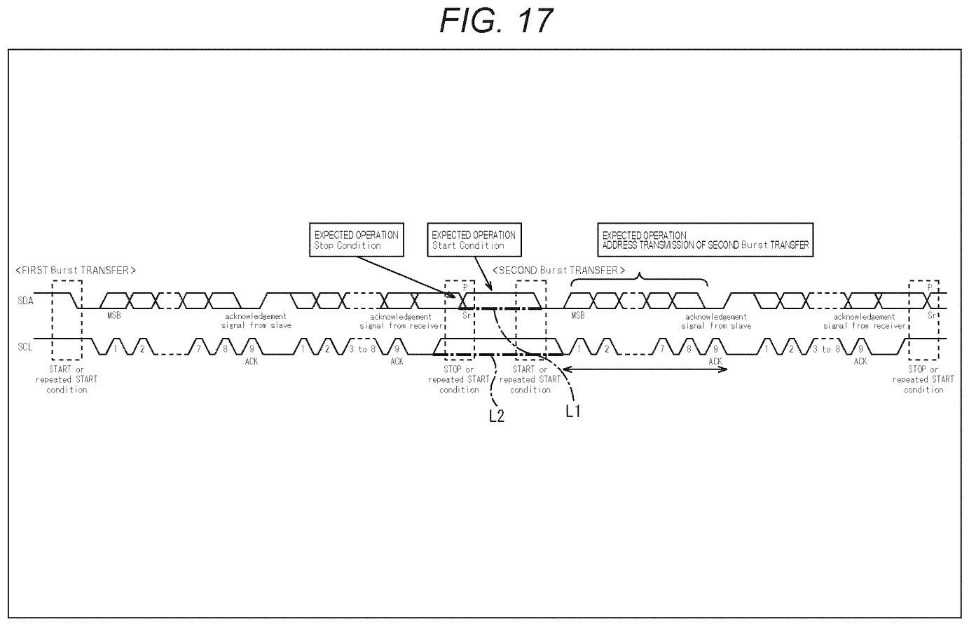

FIG. 17 is a diagram illustrating an example of an attack on the I2C communication.

The expected operation in the example of FIG. 17 is an operation of performing the second burst transfer subsequent to the first burst transfer. In this case, the stop condition and the start condition are transmitted between the first burst transfer and the second burst transfer. After the transmission of the start condition, an address is transmitted that designates a transmission destination of data by the second burst transfer.

At the time of data transmission in which such an operation is expected, as indicated by one-dot chain lines L1 and L2, in a case where an attack is performed to fix the SDA and the SCL between the first burst transfer and the second burst transfer to Low, the stop condition and the start condition are invalidated, and in the image sensor, the period is recognized as the repeated start condition.

In a case where the period is recognized as the repeated start condition, in the image sensor as the transmission destination of data by the first burst transfer, data subsequent to the repeated start condition is processed as data continuing from the data by the first burst transfer.

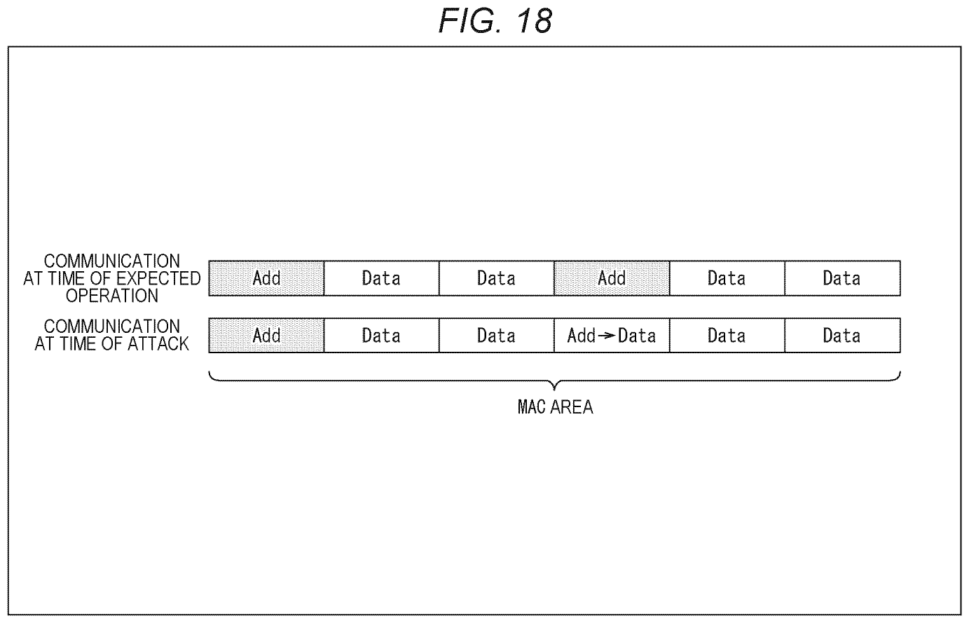

FIG. 18 is a diagram illustrating an example of data on which such an attack is made.

Each of blocks in FIG. 18 indicates 8-bit data. In a case where the expected operation is an operation of repeatedly transmitting two pieces of data subsequent to one piece of address data as illustrated in the upper part of FIG. 18, when the attack as described above is made, a series of data after the attack is in a state illustrated in the lower part of FIG. 18. In the image sensor, address data is recognized as normal data.

In security processing using a MAC value, the MAC value is calculated for the data of all the blocks (MAC area) in FIG. 18 that is data to be transmitted. Tampering performed on the data to be transmitted can be detected by the security processing using the MAC value, but in a case where tampering is performed on the condition portion, the tampering cannot be detected.

By using the above-described restriction, it is possible to detect an attack such as tampering on the condition portion that cannot be detected by the security processing using the MAC value.

### <<About SPI Communication>>

A similar restriction is set even in a case where SPI communication is performed as register communication.

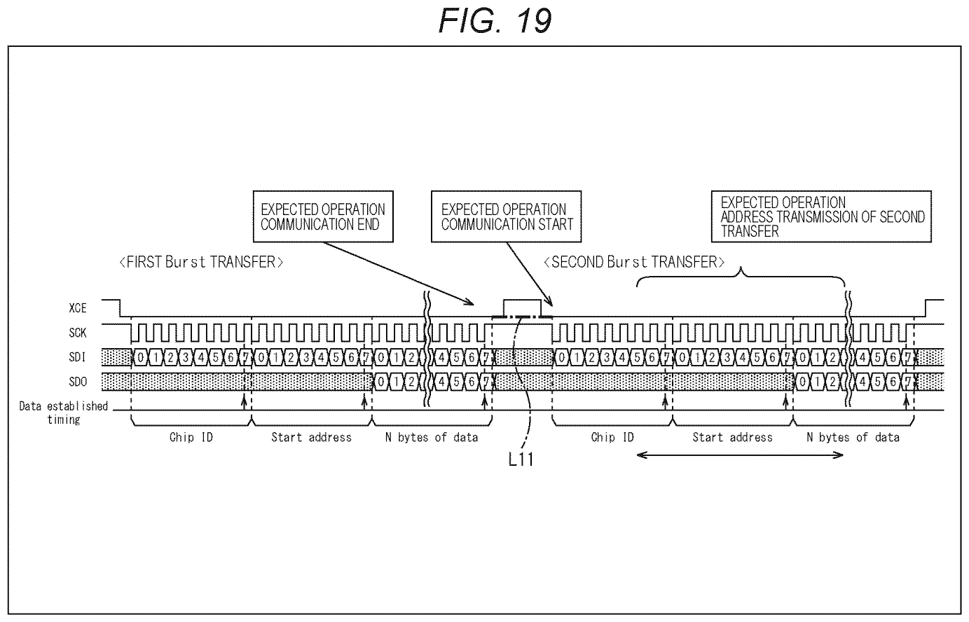

FIG. 19 is a diagram illustrating an example of data transmission by the SPI communication. The SPI communication is performed by using four signal lines: an enable line (XCE), a clock line (SCK), a data input line (SDI), and a data output line (SDO). In the communication system of FIG. 1, SDI is a line of input to the image sensor 1, and SDO is a line of output from the image sensor 1.

The data transmission by the SPI communication is in an active state (a state in which data transmission is performed) when XCE is in Low. In the Low period of XCE, a clock signal having a clock frequency f_{SCK} is transmitted by using SCK.

The expected operation in the example of FIG. 19 is an operation of performing the second burst transfer subsequent to the first burst transfer. A period during which XCE is in High is set between the first burst transfer and the second burst transfer. After XCE changes from High to Low, the second burst transfer is started, and information is transmitted such as a chip ID designating a transmission destination of data by the second burst transfer.

At the time of transmission of data in which such an operation is expected, as indicated by a one-dot chain line L11, in a case where an attack is performed to fix XCE between the first burst transfer and the second burst transfer to Low, data to be transmitted by the second burst transfer is processed as data continuing from data to be transmitted by the first burst transfer.

In the communication system of FIG. 1, a constraint is set of an interval (period of one cycle) of SCK in a period in which XCE is in Low.

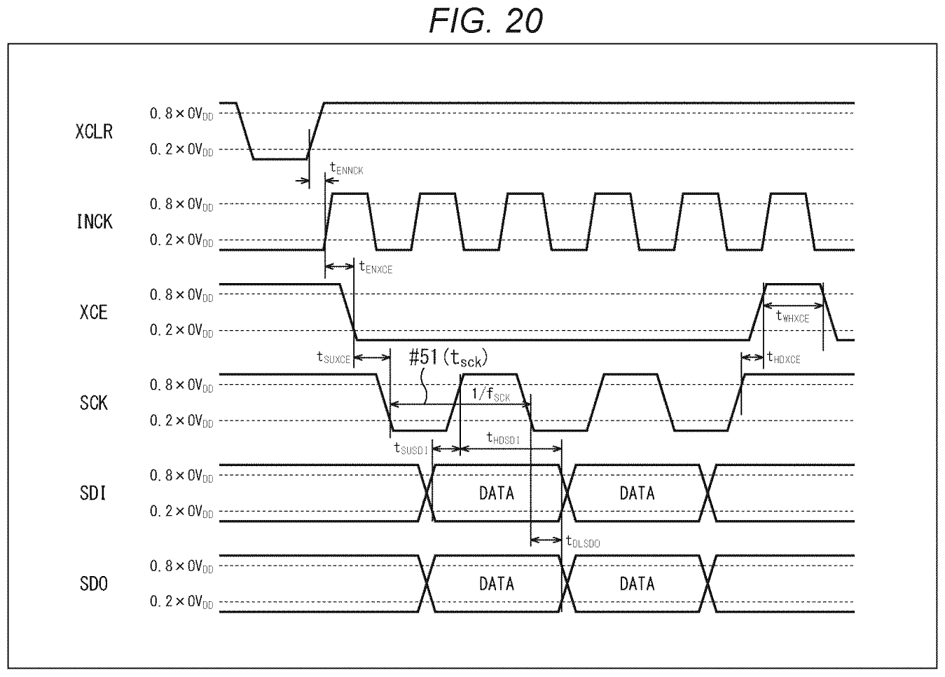

FIG. 20 is a diagram illustrating a timing chart of each of signals of the SPI.

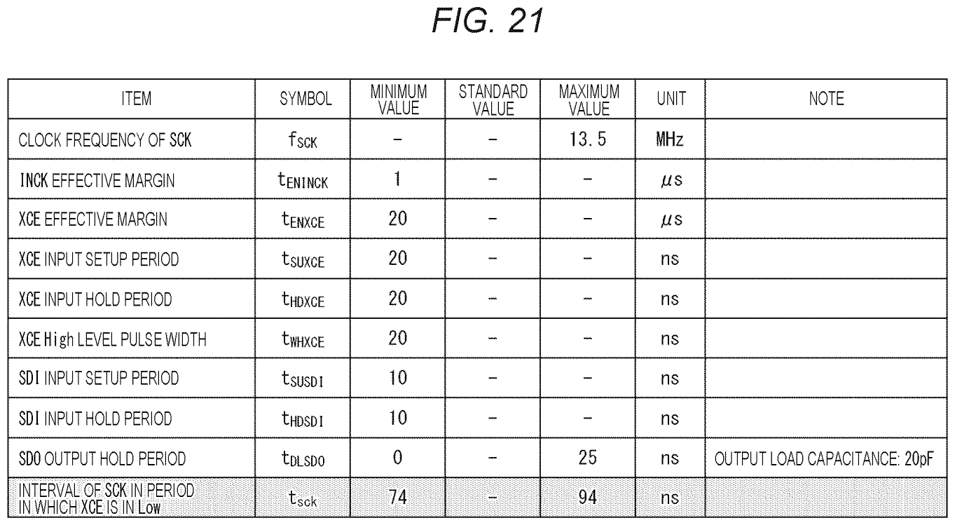

A period indicated by a bidirectional arrow #51 is a period t_{sck} that is a period for one cycle of SCK in a period in which XCE is in Low. A constraint as illustrated in FIG. 21 is set for the period t_{sck}.

In the example of FIG. 21, a constraint is set that a minimum value of the period t_{sck} is 74 ns. The minimum value 74 of the period t_{sck} is obtained by 1000/13.5(1/f_{sck})≈74.

Furthermore, a constraint is set that a maximum value of the period t_{sck} is 94 ns. The maximum value 94 of the period t_{sck} is obtained by (t_{sck} min value)/2+t_{HDXCE}+t_{WHXCE}+t_{SUXCE}.

As described above, for the period t_{sck} that is a period for one cycle of SCK in a period in which XCE is in Low, constraints are set of the shortest period and the longest period.

For example, in a case where the attack as described with reference to FIG. 19 is performed, the High period of SCK in the period is longer than a period set as the constraint. An abnormality of XCE can be detected on the basis of the fact that the High period of SCK continues longer than the constraint period.

### <<Configuration of Image Sensor>>

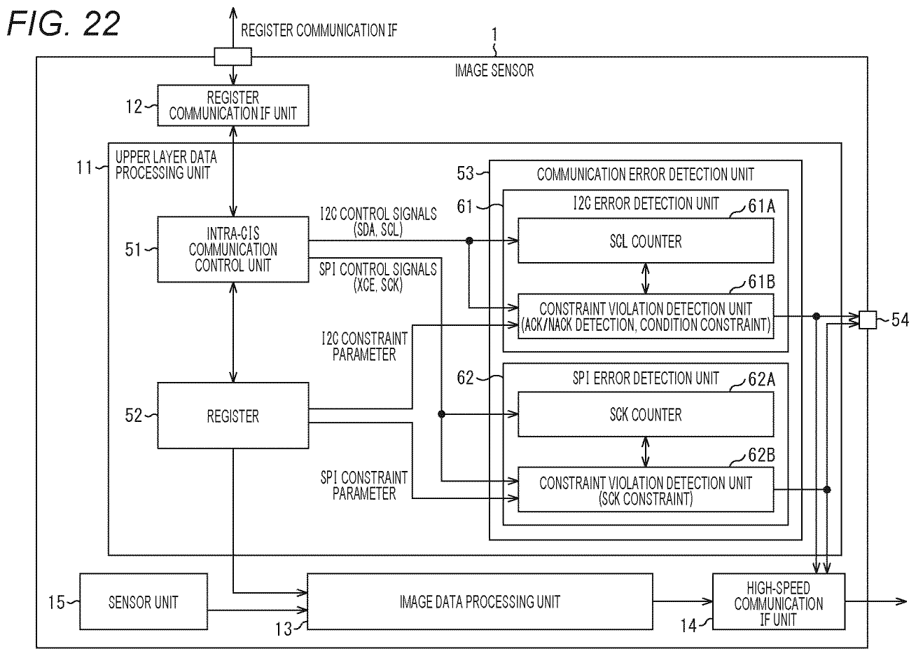

FIG. 22 is a block diagram illustrating a detailed configuration example of the image sensor 1. The same components as those described above are denoted by the same reference numerals. Redundant description will be omitted as appropriate.

The image sensor 1 is provided with a sensor unit 15 in addition to the upper layer data processing unit 11, the register communication IF unit 12, the image data processing unit 13, and the high-speed communication IF unit 14 described above.

The upper layer data processing unit 11 of the image sensor 1 includes an intra-CIS communication control unit 51, a register 52, and a communication error detection unit 53.

The intra-CIS communication control unit 51 controls communication in the image sensor 1. For example, in a case where data transmitted from the host processor 2 together with the write command is received by the register communication IF unit 12, the intra-CIS communication control unit 51 stores the data transmitted from the host processor 2 in the register 52. Information indicating an operation mode related to imaging, a parameter defining the content of the above-described constraint, and the like are stored in respective areas of the register 52.

Furthermore, in a case where the read command transmitted from the host processor 2 is received by the register communication IF unit 12, the intra-CIS communication control unit 51 reads data stored in a predetermined area of the register 52 and outputs the data to the register communication IF unit 12.

In a case where the register communication performed with the host processor 2 is the I2C communication, the intra-CIS communication control unit 51 outputs a control signal (SDA, SCL) for the I2C communication to the communication error detection unit 53. The control signal for the I2C communication is supplied to an I2C error detection unit 61 of the communication error detection unit 53.

Furthermore, in a case where the register communication performed with the host processor 2 is the SPI communication, the intra-CIS communication control unit 51 outputs a control signal (XCE, SCK) for the SPI communication to the communication error detection unit 53. The control signal for the SPI communication is supplied to an SPI error detection unit 62 of the communication error detection unit 53.

The register 52 stores the data supplied from the intra-CIS communication control unit 51. An area of information indicating ON/OFF of a function of detecting an attack on the condition portion described above may be secured in the register 52.

The data stored in areas of the register 52 are supplied to respective units. For example, information indicating an operation mode related to imaging is supplied to the image data processing unit 13. An I2C constraint parameter that is a parameter defining the content of the constraint on the I2C communication is supplied to the I2C error detection unit 61, and an SPI constraint parameter that is a parameter defining the content of the constraint on the SPI communication is supplied to the SPI error detection unit 62.

The communication error detection unit 53 detects an error (abnormality) of register communication. The communication error detection unit 53 is provided with the I2C error detection unit 61 and the SPI error detection unit 62.

The I2C error detection unit 61 that detects an abnormality in the I2C communication includes an SCL counter 61A and a constraint violation detection unit 61B.

In a case where the ACK/NACK is detected, the SCL counter 61A starts counting of periods of High/Low of the SCL and the SDA. A count value by the SCL counter 61A is supplied to the constraint violation detection unit 61B.

The processing of counting in step S1 and the processing in steps S3 and S5 in FIG. 12 are processing performed by the SCL counter 61A. Furthermore, the processing of counting in step S11 and the processing in steps S13 and S15 in FIG. 15 are also processing performed by the SCL counter 61A.

The constraint violation detection unit 61B detects the ACK/NACK on the basis of the control signal supplied from the intra-CIS communication control unit 51. In a case where the ACK/NACK is detected, information indicating the detection is supplied to the SCL counter 61A.

Furthermore, the constraint violation detection unit 61B determines whether or not the constraint set for the constraint period is satisfied on the basis of the count value supplied from the SCL counter 61A. In a case where an abnormality is detected because the constraint is not satisfied, the constraint violation detection unit 61B outputs error information indicating the detection. The error information output from the constraint violation detection unit 61B is supplied to a dedicated terminal 54 in a case where transmission of the error information to the host processor 2 is performed by using a dedicated signal line, and is supplied to the high-speed communication IF unit 14 in a case where the transmission is performed by using the high-speed communication IF.

The ACK/NACK detection processing in step S1 and the processing in steps S2, S4, and S6 in FIG. 12 are processing performed by the constraint violation detection unit 61B. Furthermore, the processing of detecting the ACK/NACK in step S11 and the processing of steps S12, S14, and S16 in FIG. 15 are also processing performed by the constraint violation detection unit 61B.

The constraint violation detection unit 61B sets the constraint on the I2C communication on the basis of the I2C constraint parameter supplied from the register 52.

The SPI error detection unit 62 that detects an abnormality in the SPI communication includes an SCK counter 62A and a constraint violation detection unit 62B.

In a case where XCE is in Low, the SCK counter 62A starts counting the period t_{sck} of SCK. A count value by the SCK counter 62A is supplied to the constraint violation detection unit 62B.

The constraint violation detection unit 62B detects that XCE is in Low on the basis of the control signal supplied from the intra-CIS communication control unit 51. In a case where it is detected that XCE is in Low, information indicating the detection is supplied to the SCK counter 62A.

Furthermore, the constraint violation detection unit 62B determines whether or not the constraint of the period t_{sck} is satisfied on the basis of the count value supplied from the SCK counter 62A. In a case where an abnormality is detected because the constraint is not satisfied, the constraint violation detection unit 62B outputs error information indicating the detection. The error information output from the constraint violation detection unit 62B is supplied to the dedicated terminal 54 in a case where transmission of the error information to the host processor 2 is performed by using a dedicated signal line, and is supplied to the high-speed communication IF unit 14 in a case where the transmission is performed by using the high-speed communication IF.

The register communication IF unit 12 performs register communication with the register communication IF unit 21 of the host processor 2, and transmits and receives various data. The register communication IF unit 12 functions as a communication unit that performs register communication with the host processor 2 serving as a master.

The image data processing unit 13 acquires pixel data output from the sensor unit 15, and performs application layer (upper layer) processing on image data of each frame. Frame data having a predetermined format is generated by the application layer processing. In the image data processing unit 13, encryption of the image data or the like is performed as appropriate. The frame data generated by the image data processing unit 13 is supplied to the high-speed communication IF unit 14.

The high-speed communication IF unit 14 performs link layer signal processing on the data supplied from the image data processing unit 13. As the link layer signal processing, generation of a packet that stores frame data, processing of distributing data of a packet to a plurality of lanes, and the like are performed. In a case where the error information is supplied from the constraint violation detection unit 61B or the constraint violation detection unit 62B, the high-speed communication IF unit 14 arranges the error information as information constituting the EBD.

Furthermore, the high-speed communication IF unit 14 performs physical layer signal processing on data of each packet. As the physical layer signal processing, processing including processing of inserting a control code into the packet distributed to each lane is performed in parallel for each lane. A data stream of each lane is transmitted from the high-speed communication IF unit 14. The high-speed communication IF unit 14 functions as a communication unit that transmits frame data including image data to the host processor 2 by using the high-speed communication IF.

In the example of FIG. 22, the I2C error detection unit 61 that detects an abnormality in the I2C communication and the SPI error detection unit 62 that detects an abnormality in the SPI communication are provided in the communication error detection unit 53, but only one of them may be provided according to the register communication compatible with the image sensor 1. For example, in a case where the register communication compatible with the image sensor 1 is the I2C communication, only the I2C error detection unit 61 is provided in the communication error detection unit 53. On the other hand, in a case where the register communication compatible with the image sensor 1 is the SPI communication, only the SPI error detection unit 62 is provided in the communication error detection unit 53.

### <<About High-Speed Communication IF>>

Here, a description will be given of SLVS-EC that is one of high-speed communication IFs.

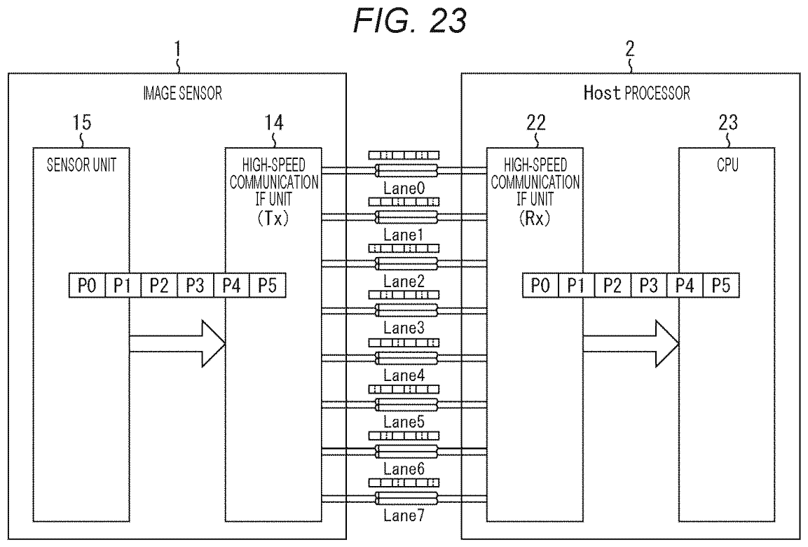

FIG. 23 is a diagram illustrating an example of data transmission by SLVS-EC.

As illustrated in FIG. 23, the sensor unit 15 and the high-speed communication IF unit 14 are provided in the image sensor 1, and the high-speed communication IF unit 22 and the CPU 23 are provided in the host processor 2. FIG. 23 illustrates only a main configuration related to data transmission using the high-speed communication IF.

The high-speed communication IF unit 14 of the image sensor 1 and the high-speed communication IF unit 22 of the host processor 2 are communication units compatible with SLVS-EC. The high-speed communication IF unit 14 serves as a communication unit on the transmission side, and the high-speed communication IF unit 22 serves as a communication unit on the reception side.

The sensor unit 15 of the image sensor 1 performs photoelectric conversion of light received via a lens. Furthermore, the sensor unit 15 performs A/D conversion and the like of a signal obtained by the photoelectric conversion, and outputs pixel data constituting an image of one frame to the high-speed communication IF unit 14 in order for every piece of data of one pixel, for example. The security processing is performed on the data output from the sensor unit 15 as described above, and the data after the security processing is output to the high-speed communication IF unit 14.

The high-speed communication IF unit 14 allocates the data of each pixel output from the sensor unit 15 to a plurality of transmission lines and transmits the data to the host processor 2 in parallel via the plurality of transmission lines. In the example of FIG. 23, transmission of the pixel data is performed by using eight transmission lines. The transmission lines between the image sensor 1 and the host processor 2 may be wired transmission lines or wireless transmission lines. Hereinafter, a transmission line between the image sensor 1 and the host processor 2 is appropriately referred to as a lane.

The high-speed communication IF unit 22 of the host processor 2 receives the pixel data transmitted from the high-speed communication IF unit 14 via the eight lanes and outputs the data of each pixel to the CPU 23 in order. As described above, data is transmitted and received by using a plurality of lanes between the high-speed communication IF unit 14 and the high-speed communication IF unit 22.

The CPU 23 acquires image data of one frame on the basis of the pixel data supplied from the high-speed communication IF unit 22, and performs various types of image processing on the acquired image data. The CPU 23 performs various types of processing such as compression of image data and recording of image data on a recording medium in addition to security processing such as decryption of encrypted image data.

In SLVS-EC, an application layer (Application Layer), a link layer (LINK Layer), and a physical layer (PHY Layer) are defined according to the content of signal processing. Link layer processing and physical layer processing are performed in each of the high-speed communication IF unit 14 and the high-speed communication IF unit 22.

As the link layer processing, for example, processing is performed for implementing the following functions.
1. Pixel data-byte data conversion
2. Error correction of payload data
3. Transmission of packet data and auxiliary data
4. Error correction of payload data using packet footer
5. Lane management
6. Protocol management for packet generation

On the other hand, as the physical layer processing, for example, processing is performed for implementing the following functions.
1. Generation and extraction of control code
2. Bandwidth control
3. Control of skew between lanes
4. Arrangement of symbols
5. Symbol coding for bit synchronization
6. SERializer/DESerializer (SERDES)
7. Generation and reproduction of clock
8. Transmission of scalable low voltage signaling (SLVS) signal

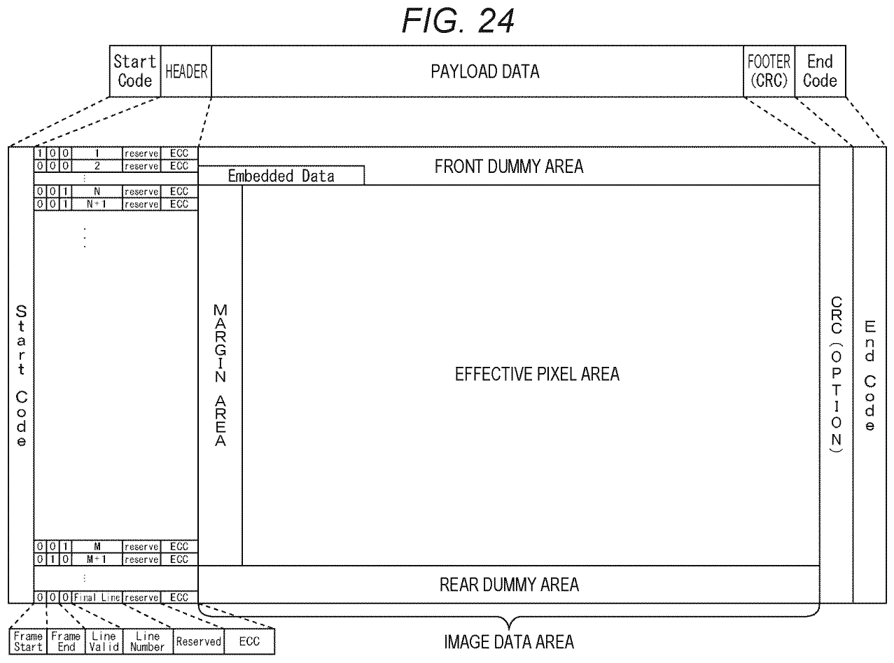

FIG. 24 is a diagram illustrating an example of a format used for the data transmission by SLVS-EC.

An effective pixel area is an area of effective pixels in an image of one frame captured by the sensor unit 15. A margin area is arranged on the left side of the effective pixel area.

A front dummy area is arranged above the effective pixel area. In the example of FIG. 24, embedded data is arranged in the front dummy area. The embedded data includes information of a setting value related to imaging by the sensor unit 15, such as a shutter speed, an aperture value, and a gain, and the like. In addition to the information of the setting value related to imaging, various types of additional information such as the error information described above are arranged as the embedded data. The embedded data is additional information added to the image data of each frame.

A rear dummy area is arranged below the effective pixel area. The embedded data may be arranged in the rear dummy area.

The effective pixel area, the margin area, the front dummy area, and the rear dummy area constitute an image data area.

A header is added before each line constituting the image data area, and a start code is added before the header. Furthermore, a footer is optionally added after each line constituting the image data area, and a control code such as an end code is added after the footer. In a case where the footer is not added, the control code such as the end code is added after each line constituting the image data area.

Data transmission is performed by using frame data in the format illustrated in FIG. 24 for each image of one frame captured by the sensor unit 15.

A band on the upper side in FIG. 24 illustrates a structure of a packet used for transmission of transmission data illustrated on the lower side. When an arrangement of data in the horizontal direction is defined as a line, data constituting one line of the image data area is stored in a payload of the packet. Transmission of the entire frame data of one frame is performed by using a number of packets, the number being larger than or equal to the number of pixels in the vertical direction of the image data area. Furthermore, the transmission of the entire frame data of one frame is performed, for example, by transmission of a packet storing data in units of lines in order from data arranged in the upper line.

The header and the footer are added to the payload in which the data for one line is stored, whereby one packet is formed. At least the start code and the end code that are control codes are added to each packet.

As illustrated in the lower left of FIG. 24, the header includes additional information on data stored in the payload, such as frame start, frame end, line valid, and line number.

The frame start is 1-bit information indicating the head of the frame. A value of 1 is set to the frame start of the header of a packet used for transmission of data of the first line in the frame data, and a value of 0 is set to the frame start of the header of a packet used for transmission of data of another line.

The frame end is 1-bit information indicating the end of the frame. A value of 1 is set to the frame end of the header of a packet including data of the end line of the frame data, and a value of 0 is set to the frame end of the header of a packet used for transmission of data of another line.

The line valid is 1-bit information indicating whether or not a line of data stored in the packet is a line of effective pixels. A value of 1 is set to the line valid of the header of a packet used for transmission of pixel data of a line in the effective pixel area, and a value of 0 is set to the line valid of the header of a packet used for transmission of pixel data of another line.

The line number is 13-bit information indicating a line number of a line in which data stored in the packet is arranged.

Even in a case where the high-speed communication IF unit 14 of the image sensor 1 and the high-speed communication IF unit 22 of the host processor 2 are IFs compatible with a standard different from SLVS-EC, transmission of image data of each frame is performed by using frame data having a similar format.

### Modifications

Transmission of error information may be performed by using the register communication IF. In this case, an area used for transmission of error information is secured in the register 52.

In the I2C communication of the communication system of FIG. 1, both the time constraint on the Low period and the time constraint on the High period of the SCL after completion of transmission of the ACK/NACK subsequent to 8-bit data are set, but only any one of the time constraints may be set. It is possible to set at least one of the time constraints of the time constraint on the Low period or the time constraint on the High period of the SCL after completion of transmission of the ACK/NACK subsequent to 8-bit data. The communication error detection unit 53 sets at least one of the time constraints of the time constraint on the Low period or the time constraint on the High period of the SCL after completion of transmission of the ACK/NACK subsequent to 8-bit data on the basis of a parameter transmitted from the host processor 2.

The constraint on the I2C communication described above can be applied not only to communication in the standard-mode, the fast-mode, and the fast-mode plus but also to communication in an ultra fast-mode (UFm).

The series of processing described above can be executed by hardware or by software. In a case where the series of processing is executed by software, a program that constitutes the software is installed to a computer incorporated in dedicated hardware, a general-purpose personal computer, or the like.

The program to be installed is provided by being recorded in a removable medium 1011 including an optical disk (compact disc-read only memory (CD-ROM), digital versatile disc (DVD), or the like), a semiconductor memory, or the like. Furthermore, the program may be provided via a wired or wireless transmission medium such as a local area network, the Internet, or digital broadcasting.

The program executed by the computer may be a program in which the processing is performed in time series in the order described in the present specification, or may be a program in which the processing is performed in parallel or at a necessary timing such as when a call is made.

In the present specification, a system means a set of a plurality of components (devices, modules (parts), and the like), and it does not matter whether or not all the components are in the same housing. Thus, a plurality of devices housed in separate housings and connected to each other through a network and a single device including a plurality of modules housed in a single housing are both systems.

The effects described in the present specification are merely examples and are not restrictive, and other effects may also be produced.

An embodiment of the present technology is not limited to the embodiment described above, and various modifications can be made without departing from the scope of the present technology.

### Examples of Combinations of Configurations

The present technology can also have the following configurations.

(1)

A communication device including:
a communication unit that performs I2C communication with an external communication device serving as a master; and
a detection unit that detects an abnormality in a condition portion generated by the external communication device on the basis of at least one of a first time constraint set for a Low period or a second time constraint set for a High period of a clock signal after completion of transmission of a response signal subsequent to data.
   (2)

The communication device according to (1), in which the detection unit detects an abnormality in a case where the Low period of the clock signal after completion of transmission of the response signal is shorter or longer than a period set as the first time constraint.

(3)

The communication device according to (1) or (2), in which the detection unit detects an abnormality in a case where the High period of the clock signal after completion of transmission of the response signal is shorter or longer than a period set as the first time constraint.

(4)

The communication device according to (3), in which the second time constraint is a period longer than or equal to a period obtained by addition of a setup period of a repeated start condition and a hold period of a start condition.

(5)

The communication device according to (3), in which the second time constraint is a period longer than or equal to a period obtained by addition of a setup period of a stop condition and a bus free period between a stop condition and a start condition.

(6)

The communication device according to any of (1) to (5), in which in a case where the abnormality in the condition portion is detected, the detection unit transmits error information indicating that the abnormality is detected to the external communication device via a predetermined signal line.

(7)

The communication device according to any of (1) to (5), further including another communication unit that generates frame data in a predetermined format used for transmission of output data in units of frames, and transmits the frame data generated to the external communication device by using a communication IF different from an IF of the I2C communication, in which
in a case where the abnormality in the condition portion is detected, the detection unit causes the frame data including error information indicating that the abnormality is detected to be transmitted to the external communication device.
   (8)

The communication device according to (7), further including a sensor unit that outputs sensor data as the output data.

(9)

The communication device according to any of (1) to (8), in which the detection unit sets a period of at least one of the first time constraint or the second time constraint on the basis of a parameter transmitted from the external communication device.

(10)

A communication method performed by a communication device, the communication method including:
performing I2C communication with an external communication device serving as a master; and
detecting an abnormality in a condition portion generated by the external communication device on the basis of at least one of a first time constraint set for a Low period or a second time constraint set for a High period of a clock signal after completion of transmission of a response signal subsequent to data.
   (11)

A program causing a computer to execute processing of:
performing I2C communication with an external communication device serving as a master; and
detecting an abnormality in a condition portion generated by the external communication device on the basis of at least one of a first time constraint set for a Low period or a second time constraint set for a High period of a clock signal after completion of transmission of a response signal subsequent to data.
   (12)

A communication device including:
a communication unit that performs I2C communication with an external communication device serving as a slave; and
a control unit that transmits, to the external device by using the I2C communication, a parameter indicating a period of at least one of a first time constraint on a Low period or a second time constraint on a High period of a clock signal after completion of transmission of a response signal subsequent to data and to be used in the external device for detection of an abnormality in a condition portion generated by the communication unit.
   (13)

The communication device according to (12), in which the control unit executes error processing in a case where error information indicating that an abnormality in the condition portion is detected is transmitted from the external communication device via a predetermined signal line.

(14)

The communication device according to (12), further including another communication unit that receives frame data in a predetermined format used for transmission of output data in units of frames transmitted from the external communication device using a communication IF different from an IF of the I2C communication, in which
the control unit executes error processing in a case where the frame data including error information indicating that an abnormality in the condition portion is detected is transmitted from the external communication device.
   (15)

A communication method performed by a communication device, the communication method including:
performing I2C communication with an external communication device serving as a slave; and
transmitting, to the external device by using the I2C communication, a parameter indicating a period of at least one of a first time constraint on a Low period or a second time constraint on a High period of a clock signal after completion of transmission of a response signal subsequent to data and to be used in the external device for detection of an abnormality in a condition portion generated by a communication unit.
   (16)

A program causing a computer to execute processing of:
performing I2C communication with an external communication device serving as a slave; and
transmitting, to the external device by using the I2C communication, a parameter indicating a period of at least one of a first time constraint on a Low period or a second time constraint on a High period of a clock signal after completion of transmission of a response signal subsequent to data and to be used in the external device for detection of an abnormality in a condition portion generated by a communication unit.

### REFERENCE SIGNS LIST

1 Image sensor
2 Host processor
11 Upper layer data processing unit
12 Register communication IF unit
13 Image data processing unit
14 High-speed communication IF unit
15 Sensor unit
21 Register communication IF unit
22 High-speed communication IF unit
23 CPU
51 Intra-CIS Communication control unit
52 Register
53 Communication error detection unit
61 I2C error detection unit
62 SPI error detection unit

1. A communication device comprising:
a communication unit that performs I2C communication with an external communication device serving as a master; and
a detection unit that detects an abnormality in a condition portion generated by the external communication device on a basis of at least one of a first time constraint set for a Low period or a second time constraint set for a High period of a clock signal after completion of transmission of a response signal subsequent to data.

2. The communication device according to claim 1, wherein the detection unit detects an abnormality in a case where the Low period of the clock signal after completion of transmission of the response signal is shorter or longer than a period set as the first time constraint.

3. The communication device according to claim 1, wherein the detection unit detects an abnormality in a case where the High period of the clock signal after completion of transmission of the response signal is shorter or longer than a period set as the second time constraint.

4. The communication device according to claim 3, wherein the second time constraint is a period longer than or equal to a period obtained by addition of a setup period of a repeated start condition and a hold period of a start condition.

5. The communication device according to claim 3, wherein the second time constraint is a period longer than or equal to a period obtained by addition of a setup period of a stop condition and a bus free period between a stop condition and a start condition.

6. The communication device according to claim 1, wherein in a case where the abnormality in the condition portion is detected, the detection unit transmits error information indicating that the abnormality is detected to the external communication device via a predetermined signal line.

7. The communication device according to claim 1, further comprising another communication unit that generates frame data in a predetermined format used for transmission of output data in units of frames, and transmits the frame data generated to the external communication device by using a communication IF different from an IF of the I2C communication, wherein
in a case where the abnormality in the condition portion is detected, the detection unit causes the frame data including error information indicating that the abnormality is detected to be transmitted to the external communication device.

8. The communication device according to claim 7, further comprising a sensor unit that outputs sensor data as the output data.

9. The communication device according to claim 1, wherein the detection unit sets a period of at least one of the first time constraint or the second time constraint on a basis of a parameter transmitted from the external communication device.

10. A communication method performed by a communication device, the communication method comprising:
performing I2C communication with an external communication device serving as a master; and
detecting an abnormality in a condition portion generated by the external communication device on a basis of at least one of a first time constraint set for a Low period or a second time constraint set for a High period of a clock signal after completion of transmission of a response signal subsequent to data.

11. A program causing a computer to execute processing of:
performing I2C communication with an external communication device serving as a master; and
detecting an abnormality in a condition portion generated by the external communication device on a basis of at least one of a first time constraint set for a Low period or a second time constraint set for a High period of a clock signal after completion of transmission of a response signal subsequent to data.

12. A communication device comprising:
a communication unit that performs I2C communication with an external communication device serving as a slave; and
a control unit that transmits, to the external device by using the I2C communication, a parameter indicating a period of at least one of a first time constraint on a Low period or a second time constraint on a High period of a clock signal after completion of transmission of a response signal subsequent to data and to be used in the external device for detection of an abnormality in a condition portion generated by the communication unit.

13. The communication device according to claim 12, wherein the control unit executes error processing in a case where error information indicating that an abnormality in the condition portion is detected is transmitted from the external communication device via a predetermined signal line.

14. The communication device according to claim 12, further comprising another communication unit that receives frame data in a predetermined format used for transmission of output data in units of frames transmitted from the external communication device using a communication IF different from an IF of the I2C communication, wherein
the control unit executes error processing in a case where the frame data including error information indicating that an abnormality in the condition portion is detected is transmitted from the external communication device.

15. A communication method performed by a communication device, the communication method comprising:
performing I2C communication with an external communication device serving as a slave; and
transmitting, to the external device by using the I2C communication, a parameter indicating a period of at least one of a first time constraint on a Low period or a second time constraint on a High period of a clock signal after completion of transmission of a response signal subsequent to data and to be used in the external device for detection of an abnormality in a condition portion generated by a communication unit.

16. A program causing a computer to execute processing of:
performing I2C communication with an external communication device serving as a slave; and
transmitting, to the external device by using the I2C communication, a parameter indicating a period of at least one of a first time constraint on a Low period or a second time constraint on a High period of a clock signal after completion of transmission of a response signal subsequent to data and to be used in the external device for detection of an abnormality in a condition portion generated by a communication unit.
